(19) United States
(12) Patent Application Publication
(10) Pub. No.: US 2016/0104360 A1
(43) Pub. Date: Apr. 14, 2016

(54) PAIRED PROXIMITY ALARM TAGS

(71) Applicant: International Business Machines Corporation, Armonk, NY (US)

(72) Inventors: Galina Grunin, Briarcliff Manor, NY (US); David Edward Nachman, Stamford, CT (US); Nader M. Nassar, Yorktown Heights, NY (US); Tamer Nassar, Bethel, CT (US)

(21) Appl. No.: 14/512,405

(22) Filed: Oct. 11, 2014

(51) Int. Cl. G08B 21/18

(52) U.S. Cl. CPC G08B 21/18

(57) ABSTRACT

A method includes pairing at least two tags and attaching each one of the at least two tags to objects; a computer device sensing the proximity of each tagged object; and the computer device issuing alerts depending on the sensed proximity of each tagged object, wherein a first alert is triggered when one of the tagged objects leaves a secured area without a corresponding paired tagged object.

### BACKGROUND

The present invention relates to paired proximity alarm tags, and more specifically, to using paired proximity alarm tags to trigger alerts if the tags are separate at a control point.

### SUMMARY

According to one aspect of the present invention, a method includes pairing at least two tags and attaching each one of the at least two tags to objects; a computer device sensing the proximity of each tagged object; and the computer device issuing alerts depending on the sensed proximity of each tagged object, wherein a first alert is triggered when one of the tagged objects leaves a secured area without a corresponding paired tagged object.

According to another aspect of the present invention, a system includes: one or more processors, one or more computer-readable memories and one or more computer-readable, tangible storage devices; a pairing module operatively coupled to at least one of the one or more storage devices for execution by at least one of the one or more processors via at least one of the one or more memories, configured to pair at least two tags and attaching each one of the at least two tags to objects; a sensing module operatively coupled to at least one of the one or more storage devices for execution by at least one of the one or more processors via at least one of the one or more memories, configured to sense the proximity of each tagged object; and an alert module operatively coupled to at least one of the one or more storage devices for execution by at least one of the one or more processors via at least one of the one or more memories, configured to issue alerts depending on the sensed proximity of each tagged object, wherein a first alert is triggered when one of the tagged objects leaves a secured area without a corresponding paired tagged object.

According to yet another aspect of the present invention, a computer program product includes: one or more computer-readable, tangible storage medium; program instructions, stored on at least one of the one or more storage medium, to pair at least two tags and attaching each one of the at least two tags to objects; program instructions, stored on at least one of the one or more storage medium, to determine sense the proximity of each tagged object; and program instructions, stored on at least one of the one or more storage medium, to issue alerts depending on the sensed proximity of each tagged object, wherein a first alert is triggered when one of the tagged objects leaves a secured area without a corresponding paired tagged object.

### BRIEF DESCRIPTION OF THE SEVERAL VIEWS OF THE DRAWINGS

FIG. 1 shows a flowchart according to an embodiment of the present invention.

FIGS. 2A and 2B show an exemplary implementation according to an embodiment of the present invention.

FIGS. 3 and 4 show another exemplary implementation according to an embodiment of the present invention.

FIGS. 5A-5C show still another exemplary implementation according to an embodiment of the present invention.

FIG. 6 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

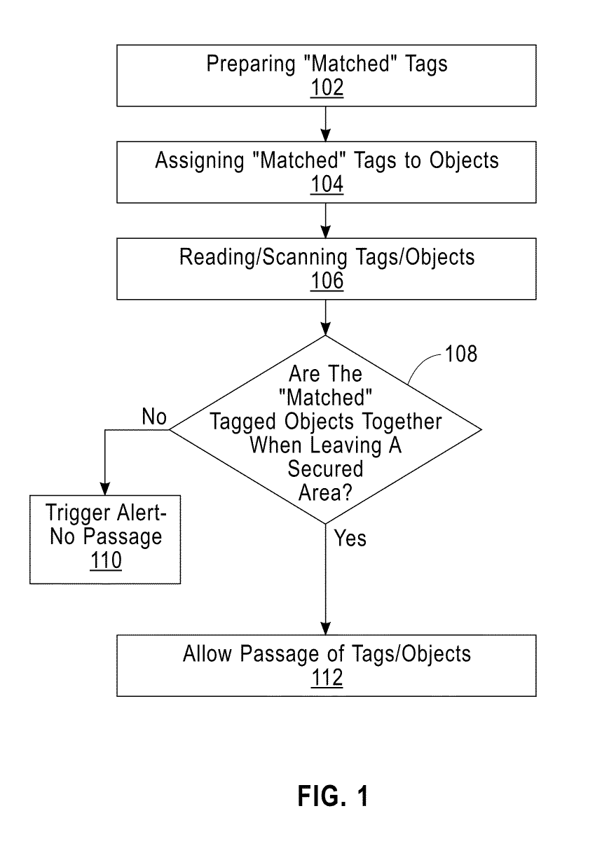

Now referring to FIG. 1, a process for an embodiment of the present invention relates to a controlled area alert system which prevents some objects from leaving or passing the controlled area without the association of other objects assigned to the same group. The process starts with the pairing of matched tags (102). Tags could be purchased as pre-programmed tags and sold in a commercial packages for use in airport security. The tags may be used for luggage security, child security, or customized for advanced security set up and integrated with a rule/role based security paradigm. For additional security, the tags could be programmed with more information and a logic layer could be added to govern the pairing process. For example, to access high security areas, pairs of 2nd line manager may be the only one allowed access. As a result, access will not be cleared if a first line manager or below is paired with a 2nd line manager trying to access that particular secure area. The process continues by assigning the matched tags to objects (104). The objects may be people, pets, luggage's or paper items which then be associated with paired tags. Once the matched tags/objects are deployed for use within secured areas, the process then reads/scans the matched tags/objects (106) and determines if the matched tagged objects are together when leaving or entering a secured area (108). The decision process for determining the physical presence of matched tagged objects leaving or entering the secured area is based on the proximity of the matched tagged objects to one another. The process triggers one alert if only one of the matched paired objects exits or enters a secured area (110). The alert may be a gated mechanism that blocks passage or initiates some other warning security system. The process triggers another alert if both of the matched paired objects exits or enters the secured area (112). Other embodiments of the present invention may include a plurality of matched paired objects and will be described hereafter. It is further noted that the alert may trigger specific actions depending on which one of the matched objects leaves the secured area without it's corresponding paired tagged object.

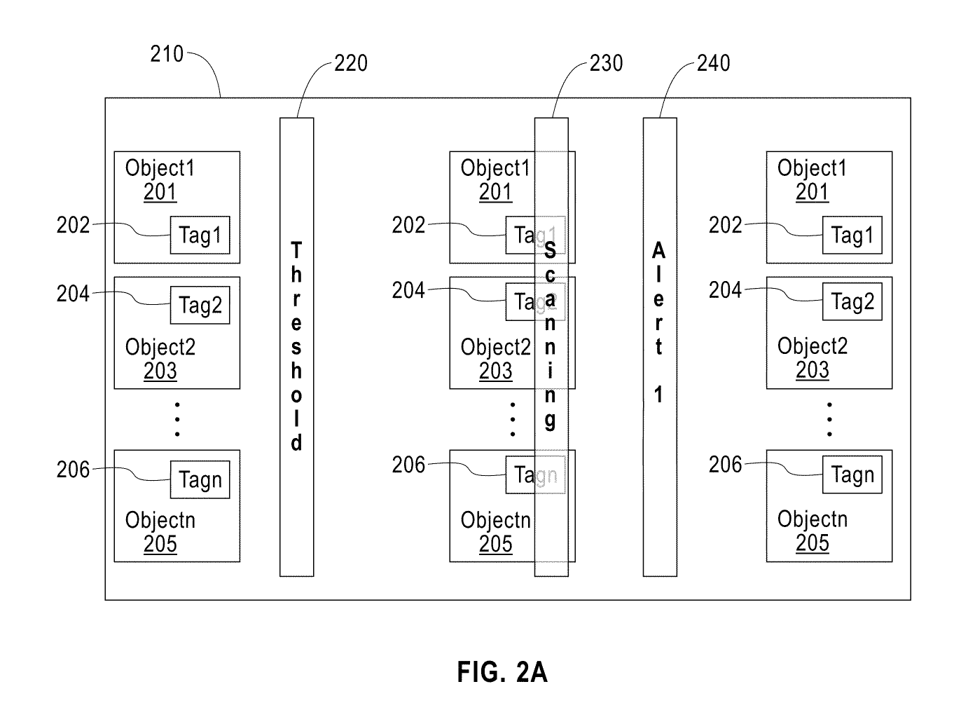

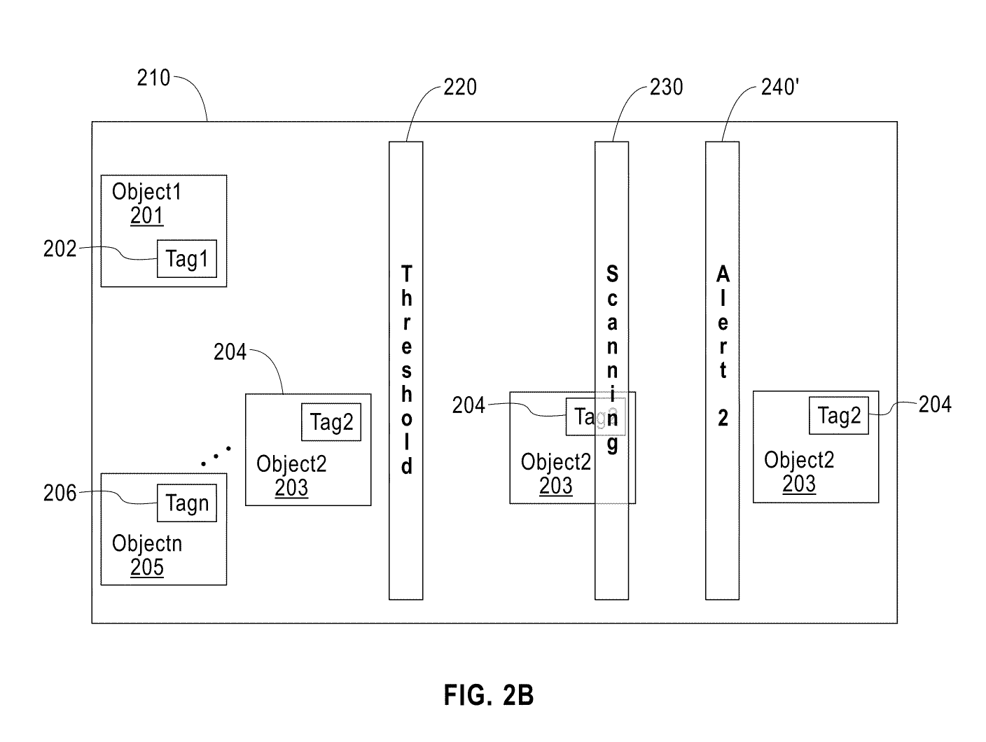

Referring to FIGS. 2A and 2B, an exemplary implementation according to an embodiment of the present invention is depicted. A secured area 210 includes objects (201, 203, 205) and their attached respective tags (202, 204, 206). As the objects (201, 203, 205) and tags (202, 204, 206) pass a threshold 220 they are scanned via a scanner 230. Since each of the objects (201, 203, 205) and tags (202, 204, 206) are within the proximity range of each other, they trigger an alert to allow passage thereby leaving the secured area 210. Another aspect of the present invention is to trigger an alert when only one of the tagged objects leaves the secured area 210. As shown in FIG. 2B, object 203 and it's tag 204 moves away from the proximity of the corresponding matched tagged objects (201, 205) and tags (202, 206). When the tagged object 203/204 reaches the threshold 220 it is scanned 230. The scanner 230 triggers yet another alert 240′ and the tagged object 203/204 is either blocked from leaving the secured area 210 or the alert triggers an alarm thereby notifying security personnel that only one of the tagged object 203/204 is leaving the secured area 210.

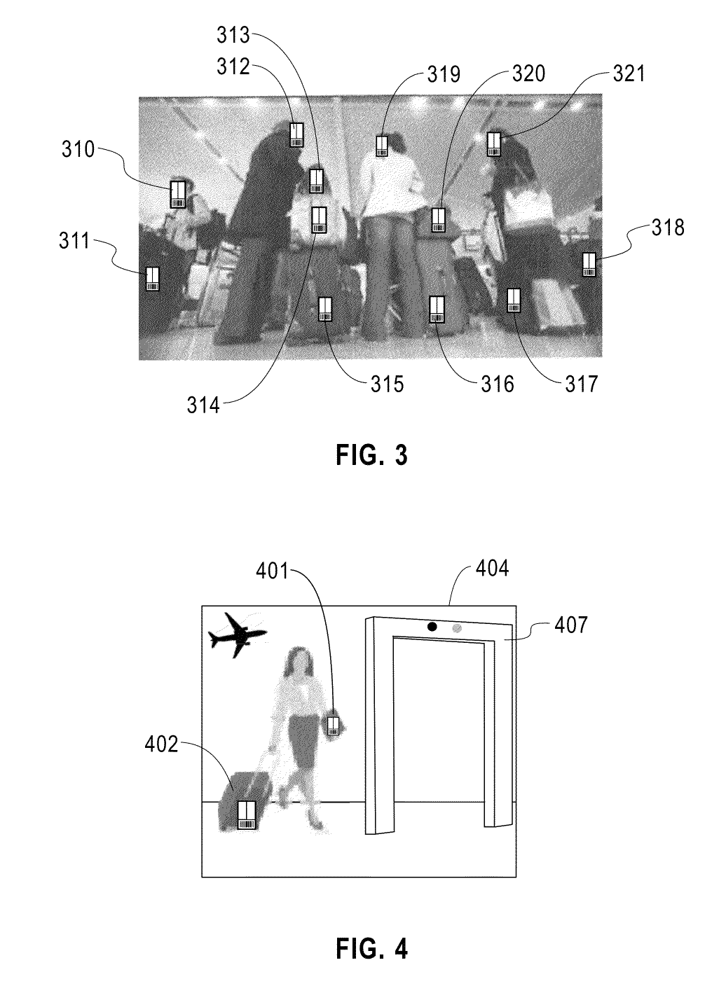

Referring to FIGS. 3 and 4, another exemplary implementation according to an embodiment of the present invention is depicted. In airports where passengers must be in company of their luggage especially when leaving the airport or custom clearance area. In this scenario the system could identify:
Luggage being removed by thief
A passenger leaving the area without claiming their luggage (this might be important for homeland security)
Luggage mistakenly taken by a passenger due to similarity to the passenger's own items
Enclosed parks/children play area where the guardian and the children are paired with the proximity security tags. A flag/alarm will go off if the guardian leaves the premise without the child or visa versa.
High secure areas where individual access is not granted, paired proximity security tags could be used, such as a dentention center or data center.

Still referring to FIGS. 3-4, shown is a group of passengers accompany their respect luggage. People with either luggage claim checks and/or boarding passes with attached tags (310, 312, 319 and 321) are electronically paired with tags (311, 313-318 and 320) attached to the passengers' luggage. It is noted that passengers may include more than one piece of luggage. The tags (310, 312, 319 and 321) associated with the claim checks/boarding passes are considered the primary tag. The tags (311, 313-318 and 320) attached to the luggage are secondary tags. When both the tagged luggage claim check and/or boarding pass 401 go through the security gate 407 with the tagged luggage 402, the security gate 407 indicates a green “ok” pass signal. If the passenger were to leave the security area with only the luggage claim check and/or boarding pass 401, the security gate 407 would indicate a red “flag” signal to alert security personnel. Conversely, if one were to leave the security area with only the tagged luggage 402, the security gate 407 would indicate a red “flag” signal to alert security personnel. This warning could be a lower tier “Red” warning.

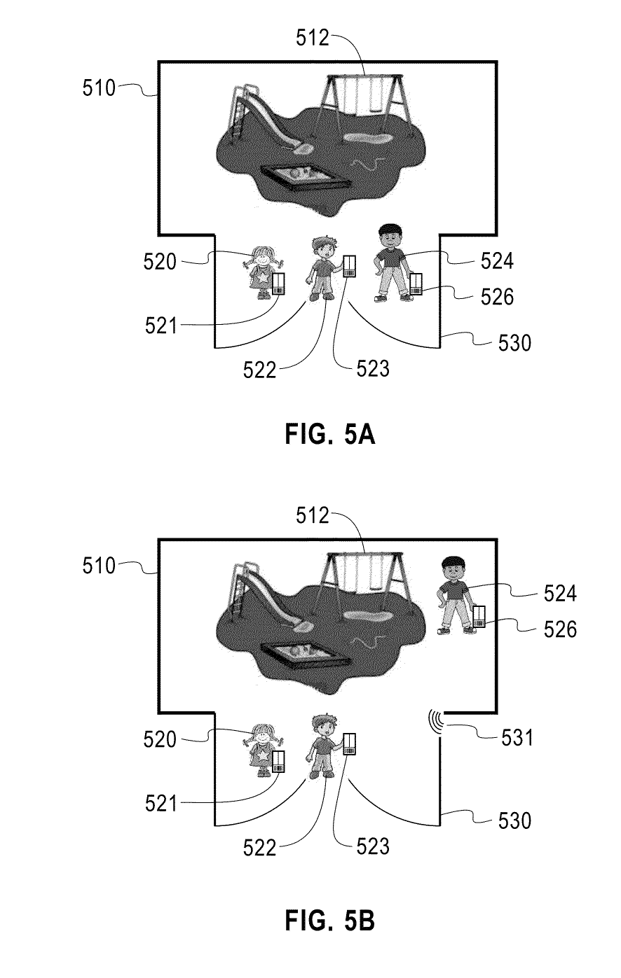

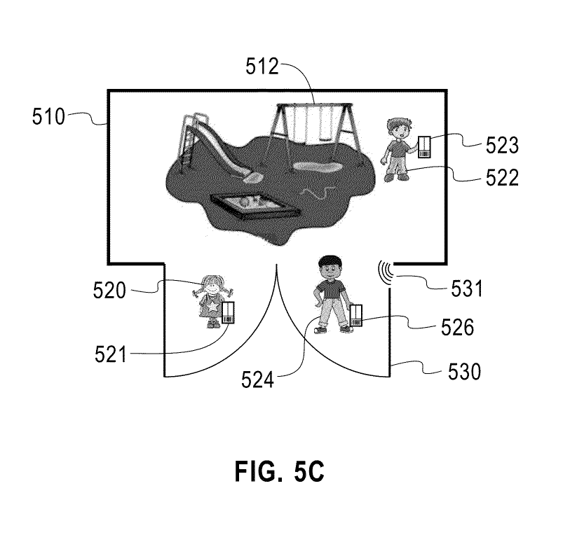

Referring to FIGS. 5A-5C, still another exemplary implementation according to an embodiment of the present invention is depicted. When parents take their children to play areas 512 or theme parks, security and protection of the children is important. Parents 524 and their children (520, 522) are issued respected tags 526, 521 and 523. The play area 512 is surrounded by a sensing barrier 510. When the tagged parents 524 and children (520, 522) leave the secured area together, the security gate 530 allows them to leave. As described earlier, if all the tagged people are not leaving together then a security alarm 521 is triggered and the gate 530 prevents them from leaving. This applies to children leaving without the parent or if a parent leaves a child behind.

With reference to configurable proximity, tags proximity may be configurable so that alerts at the perimeter would be able to assess the time elapsed from passing one tag and the other. Example, parent/child tags would require a shorter proximity while dog/dog walker tags may be configured with a more relaxed/elongated proximity. Configurable alerts are further possible. Different tags may be configured to initiate different/defined alerts. For example, parent tags could trigger code purple alert while child tags could trigger 911 alert. Similarly, Luggage tag could trigger security alert, while passenger (luggage owner) tag could trigger a different type of alerts.

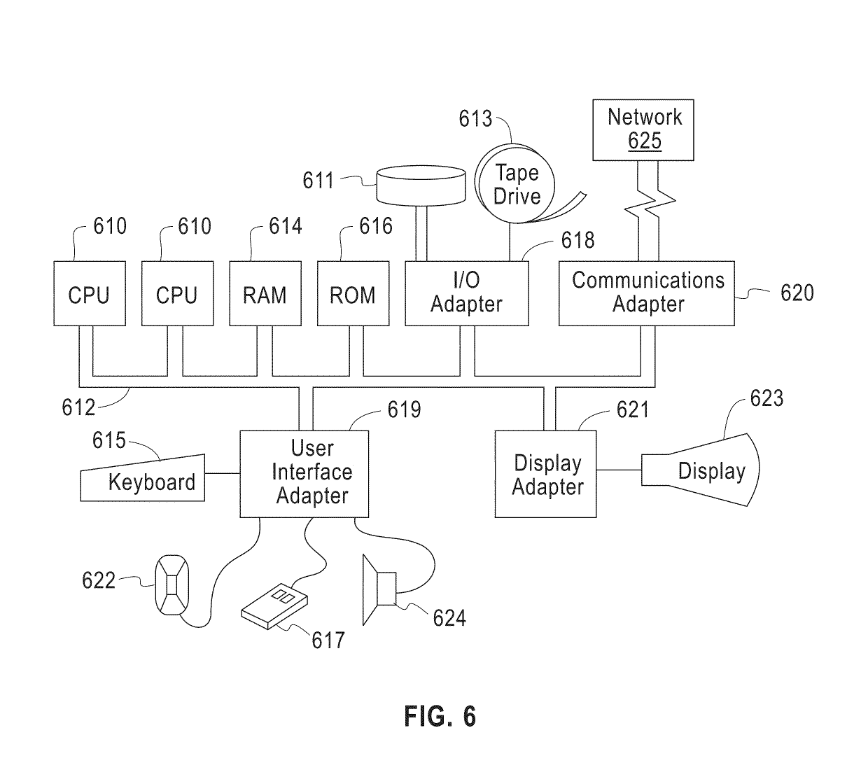

Referring now to FIG. 6, this schematic drawing illustrates a hardware configuration of an information handling/computer imaging system in accordance with the embodiments of the invention. The system comprises at least one processor or central processing unit (CPU) 610. The CPUs 610 are interconnected via system bus 612 to various devices such as a random access memory (RAM) 614, read-only memory (ROM) 616, and an input/output (I/O) adapter 618. The I/O adapter 618 can connect to peripheral devices, such as disk units 611 and tape drives 613, or other program storage devices that are readable by the system. The system can read the inventive instructions on the program storage devices and follow these instructions to execute the methodology of the embodiments of the invention. The system further includes a user interface adapter 619 that connects a keyboard 615, mouse 617, speaker 624, microphone 622, and/or other user interface devices such as a touch screen device (not shown) to the bus 612 to gather user input. Additionally, a communication adapter 620 connects the bus 612 to a data processing network 625, and a display adapter 621 connects the bus 612 to a display device 623 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
pairing at least two tags and attaching each one of the at least two tags to objects;
a computer device sensing the proximity of each tagged object; and
the computer device issuing alerts depending on the sensed proximity of each tagged object, wherein a first alert is triggered when one of the tagged objects leaves a secured area without a corresponding paired tagged object.

2. The method according to claim 1, wherein the computer device issues a second alert when each of the tagged objects leaves the secured area in close proximity.

3. The method according to claim 1, wherein each of the tags are physically attached to their respective objects.

4. The method according to claim 1, wherein the pairing of the at least two tags includes a primary tag and a secondary tag.

5. The method according to claim 4, wherein the pairing of the at least two tags includes configurable proximity tags.

6. The method according to claim 1, wherein the first alert triggers a security apparatus to prevent one of the tagged objects from leaving the secured area.

7. The method according to claim 2, wherein the second alert triggers a security apparatus to allow each of the tagged objects to leave the secured area.

8. A system comprising:
one or more processors, one or more computer-readable memories and one or more computer-readable, tangible storage devices;
a pairing module operatively coupled to at least one of the one or more storage devices for execution by at least one of the one or more processors via at least one of the one or more memories, configured to pair at least two tags and attaching each one of the at least two tags to objects;
a sensing module operatively coupled to at least one of the one or more storage devices for execution by at least one of the one or more processors via at least one of the one or more memories, configured to sense the proximity of each tagged object; and
an alert module operatively coupled to at least one of the one or more storage devices for execution by at least one of the one or more processors via at least one of the one or more memories, configured to issue alerts depending on the sensed proximity of each tagged object, wherein a first alert is triggered when one of the tagged objects leaves a secured area without a corresponding paired tagged object.

9. The system according to claim 8, wherein the alert module issues a second alert when each of the tagged objects leaves the secured area in close proximity.

10. The system according to claim 8, wherein each of the tags are physically attached to their respective objects.

11. The system according to claim 8, wherein the pairing of the at least two tags includes a primary tag and a secondary tag.

12. The system according to claim 11, wherein the pairing of the at least two tags includes configurable proximity tags.

13. The system according to claim 8, wherein the first alert triggers a security apparatus to prevent one of the tagged objects from leaving the secured area.

14. The system according to claim 9, wherein the second alert triggers a security apparatus to allow each of the tagged objects to leave the secured area.

15. A computer program product comprising:
one or more computer-readable, tangible storage medium;
program instructions, stored on at least one of the one or more storage medium, to pair at least two tags and attaching each one of the at least two tags to objects;
program instructions, stored on at least one of the one or more storage medium, to determine sense the proximity of each tagged object; and
program instructions, stored on at least one of the one or more storage medium, to issue alerts depending on the sensed proximity of each tagged object, wherein a first alert is triggered when one of the tagged objects leaves a secured area without a corresponding paired tagged object.

16. The computer program product according to claim 15, further includes program instructions, stored on at least one of the one or more storage medium, to issue a second alert when each of the tagged objects leaves the secured area in close proximity.

17. The computer program product according to claim 15, wherein each of the tags are physically attached to their respective objects.

18. The computer program product according to claim 15, wherein the pairing of the at least two tags includes a primary tag and a secondary tag.

19. The computer program product according to claim 18, wherein the pairing of the at least two tags includes configurable proximity tags.

20. The computer program product according to claim 16, wherein the first alert triggers a security apparatus to prevent one of the tagged objects from leaving the secured area and the second alert triggers a security apparatus to allow each of the tagged objects to leave the secured area.
